(19) United States
(12) Patent Application Publication
(10) Pub. No.: US 2026/0129353 A1
(43) Pub. Date: May 7, 2026

(54) ELECTRONIC DEVICE INCLUDING SPEAKER

(71) Applicant: SAMSUNG ELECTRONICS CO., LTD., Suwon-si (KR)

(72) Inventors: Hunki LEE, Suwon-si (KR); Kiwon KIM, Suwon-si (KR); Taeeon KIM, Suwon-si (KR); Seongkwan YANG, Suwon-si (KR); Taeyoung PARK, Suwon-si (KR); Woojin CHO, Suwon-si (KR); Joonrae CHO, Suwon-si (KR)

(21) Appl. No.: 19/440,789

(22) Filed: Jan. 6, 2026

Related U.S. Application Data
(63) Continuation of application No. PCT/KR2024/010287, filed on Jul. 17, 2024.

(30) Foreign Application Priority Data
Jul. 17, 2023 (KR) 10-2023-0092457
Aug. 9, 2023 (KR) 10-2023-0104190

(51) Int. Cl. H04R 1/28; G06F 1/16

(52) U.S. Cl. CPC H04R 1/2811; G06F 1/1605; H04R 2499/15

(57) ABSTRACT

An electronic device includes a vibration (sound) generator having a center in a first direction, and a sound conduit through which the sound is transmitted. The sound conduit includes an opening through which the sound is transmitted to outside, a first sound conduit connected to the opening at a first end of the first sound conduit, and a second sound conduit connected to a second end of the first sound conduit, the first sound conduit extending a first length in the first direction from the opening, the second sound conduit extending a second length in the first direction from the second end of the first sound conduit, and the first sound conduit extending a third length in the first direction from the center of the vibration generator to the second end of the first conduit. The second length is derived based on the first length and the third length.

### CROSS-REFERENCE TO RELATED APPLICATIONS

This application is a continuation application of International Application No. PCT/KR2024/010287 designating the United States, filed on Jul. 17, 2024, in the Korean Intellectual Property Receiving Office and claiming priority to Korean Patent Application No. 10-2023-0092457, filed on Jul. 17, 2023, and Korean Patent Application No. 10-2023-0104190, filed on Aug. 9, 2023, in the Korean Intellectual Property Office, the disclosures of which are incorporated by reference herein in their entireties.

### BACKGROUND

### (1) Field

The present disclosure relates to an electronic device including a speaker.

### (2) Description of the Related Art

An electronic device (e.g., a speaker device) may include a conduit unit disposed on the front surface of a vibration unit (e.g., a speaker unit). Sound generated by the vibration unit may be radiated to the side surface of the electronic device through the conduit unit.

The sound pressure level (SPL) generated by a vibration unit may vary depending on changes in the frequency of the vibration unit. Depending on the changes in the frequency of the vibration unit, the sound pressure level may include local peaks and troughs.

### SUMMARY

For the improvement of the low-frequency acoustic performance of an electronic device (e.g., a speaker device), a relatively large-sized vibration unit (e.g., a speaker unit) may be included. As the size of the vibration unit increases, the distance from the center to the edge of the vibration unit may increase. As the distance from the center to the edge of the vibration unit increases, the sound quality of the electronic device may deteriorate because of the local troughs in the sound pressure level.

Therefore, a structure is desired which can reduce the performance degradation of an electronic device (e.g., a speaker device) which include a relatively large-sized vibration unit.

An electronic device according to an embodiment of the present disclosure includes a vibration unit for generating a sound, and a conduit unit which is formed on the front surface of the vibration unit, and which is the space through which the sound generated by the vibration unit is transmitted, where the conduit unit includes a radiation opening for transmitting the sound to the outside of the electronic device, a first tube, which is connected to the radiation opening at one end thereof and extends a first length, and a second tube, which is connected to the first tube at the other end of the first tube, extends a second length in the direction opposite to that of the radiation opening, and is shaped to have a closed end, and the second length can be determined on the basis of the first length and a third length, which is the length from the center of the vibration unit to the other end of the first tube.

An electronic device according to an embodiment of the present disclosure includes a vibration unit which generates sound, a support unit which surrounds the vibration unit, a cover which is disposed to be spaced apart from the vibration unit, and a conduit unit formed by the cover and the support unit, where the conduit unit may include a radiation opening for transmitting the sound to the outside of the electronic device, a first tube, which is connected to the radiation opening at one end thereof and extends a first length, and a second tube, which is connected to the first tube at the other end of the first tube, extends a second length in the direction opposite to that of the radiation opening, and is shaped to have a closed end.

An electronic device according to an embodiment of the present disclosure may include a separate closed tube to improve the acoustic performance of the electronic device.

An electronic device according to an embodiment of the present disclosure may eliminate second peaks and troughs in sound pressure level according to frequency changes of a vibration unit by including a separate closed tube.

An electronic device according to an embodiment of the present disclosure may utilize various frequency bands by eliminating second peaks and troughs in sound pressure levels, thereby further improving the acoustic performance of the electronic device.

### BRIEF DESCRIPTION OF THE DRAWINGS

The above and other aspects, features, and advantages of specific embodiments of the present disclosure will become clearer from the following detailed description, which is provided together with the accompanying drawings.

FIG. 1 is a block diagram of an electronic device within a network environment according to an embodiment.

FIGS. 2a, 2b, and 2c are perspective views illustrating an electronic device according to an embodiment of the present disclosure.

FIG. 3 is a cross-sectional side view of a vibration unit and a conduit unit of an electronic device according to an embodiment of the present disclosure.

FIG. 4 is a plan view of a vibration unit and a conduit unit of the electronic device according to an embodiment of the present disclosure.

FIG. 5 is an enlarged perspective view of an electronic device according to an embodiment of the present disclosure.

FIGS. 6a, 6b, and 6c are perspective views of an electronic device according to an embodiment of the present disclosure.

FIG. 7 is a plan view of a vibration unit and a conduit unit according to an embodiment of the present disclosure.

FIGS. 8a and 8b are cross-sectional side views illustrating an electronic device according to an embodiment of the present disclosure.

FIGS. 9a and 9b are cross-sectional side views illustrating an electronic device according to an embodiment of the present disclosure.

FIG. 10 is a cross-sectional side view illustrating an electronic device according to an embodiment of the present disclosure.

FIG. 11 is a plan view of an electronic device according to an embodiment of the present disclosure.

FIG. 12 is a graph illustrating the sound pressure level of an electronic device according to an embodiment of the present disclosure.

### DETAILED DESCRIPTION

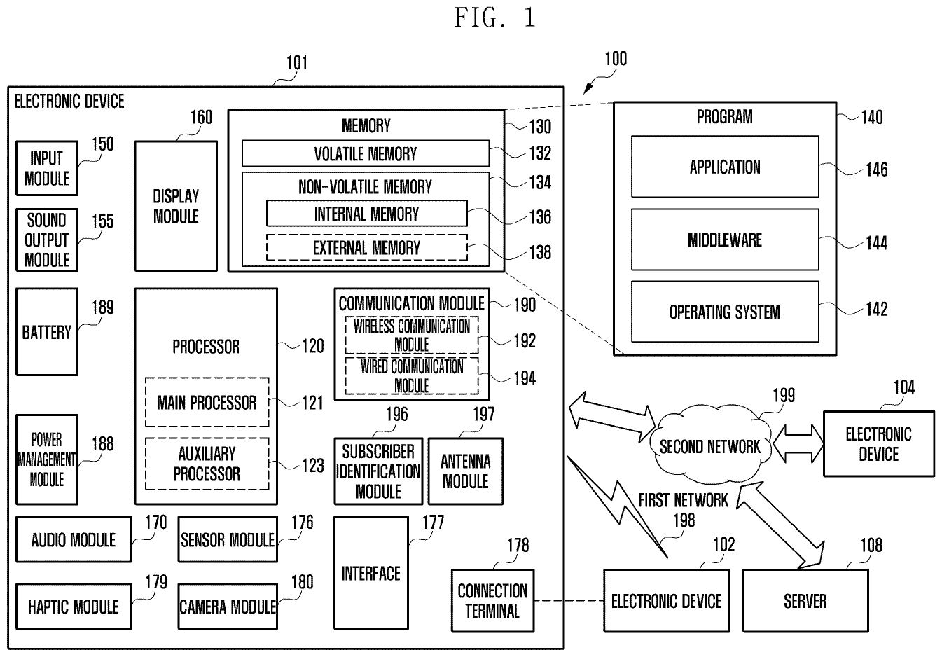

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) which is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors which are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

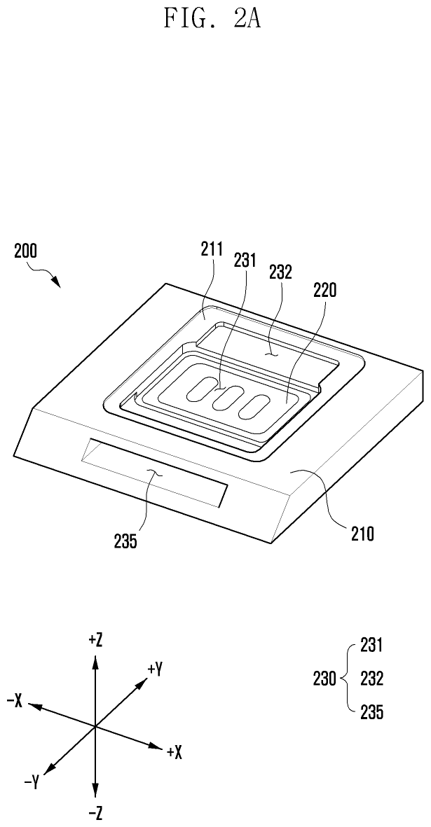

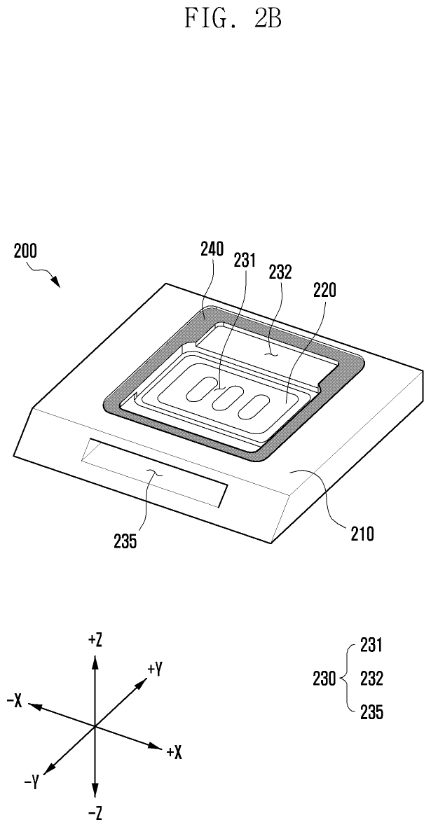

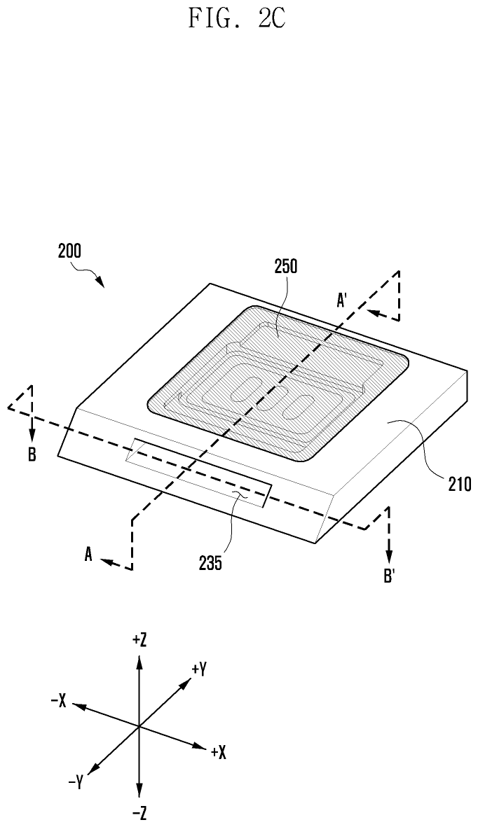

FIGS. 2a, 2b, and 2c are perspective views illustrating an electronic device according to an embodiment of the present disclosure.

The electronic device 200 of FIGS. 2a, 2b, and 2c may include at least some of the components of the electronic device 101 of FIG. 1.

An electronic device 200 according to an embodiment of the present disclosure may include a support unit 210, a vibration unit 220, a conduit unit 230, an adhesive member 240, and/or a cover 250.

In describing an electronic device 200 according to an embodiment of the present disclosure, the width direction of the electronic device 200 may mean the X-axis direction (or a second direction), and the length direction of the electronic device 200 may mean the Y-axis direction (or a first direction). The height direction (or the thickness direction) of the electronic device 200 may mean the Z-axis direction (or a third direction).

In an embodiment, the electronic device 200 may mean (or define) a speaker device, a speaker module, and/or a speaker system, or may include a speaker device, a speaker module, and/or a speaker system. For example, the electronic device 200 illustrated in FIGS. 2a, 2b, and 2c may be a speaker device which serves to output an acoustic signal.

In an embodiment, the vibration unit 220 may be a constitution which generates sound (e.g., an audio signal) through vibration. For example, the vibration unit 220 may mean a speaker unit which generates sound, or may include a speaker unit.

With reference to FIG. 2a, the vibration unit 220 may be disposed inside the support unit 210. For example, the vibration unit 220 may be at least partially surrounded by the support unit 210. The support unit 210 may define a base or support body of the electronic device 200, without being limited thereto. The vibration unit 220 may define a vibrator of the electronic device 200, without being limited thereto. The vibration unit 220 as a vibration generator may include a vibrator, without being limited thereto.

In an embodiment, the support unit 210 may include a seating unit 211. The seating unit 211 may be defined by the base or body. The seating unit 211 may be a recess or volume in which a component is received or disposed. With reference to FIG. 2a, the seating unit 211 may be formed (or provided) in a shape which surrounds the periphery of the vibration unit 220. The shape may be defined in the the plan view (e.g., a planar shape), that is, a view along the Z-axis direction which crosses a plane defined by the X-axis direction and the Y-axis direction crossing each other.

With reference to FIG. 2b, an adhesive member 240 may be disposed on (or in) the seating unit 211 of the support unit 210. The adhesive member 240 may serve to couple the cover 250 to the support unit 210. The adhesive member 240 may include an adhesive material (e.g., bonding member or double-sided tape).

With reference to FIG. 2c, a cover 250 may be disposed on the support unit 210. The cover 250 may be coupled to the support unit 210 by an adhesive member 240.

In an embodiment, at least a portion of the conduit unit 230 may be formed in the front direction of the vibration unit 220. The front direction of the vibration unit 220 may mean a direction facing the positive Z-axis direction in the vibration unit 220. In an embodiment, the conduit unit 230 as a sound conduit may be a space through which sound generated from the vibration unit 220 is transmitted. The space may be an audio path along which sound is transmitted.

In an embodiment, the conduit unit 230 may be formed by the support unit 210 and the cover 250. For example, the conduit unit 230 may be a space at least partially surrounded by the support unit 210 and the cover 250. The space may be an empty space or volume defined by the support unit 210 coupled to the cover 250.

In an embodiment, the conduit unit 230 may include a radiation opening 235 at one end of the audio path. Sound generated from the vibration unit 220 may be transmitted to the outside of the electronic device 200, through the radiation opening 235. The radiation opening 235 may be defined as an opening defined in a side of the support unit 210 which is connected to the first tube 231 by a sound output conduit, or may refer to the sound output conduit connecting the first tube 231 to the opening in the side of the support unit 210.

In an embodiment, the radiation opening 235 may be formed on (or in) a side surface of the electronic device 200. The side surface of the electronic device 200 may be a surface facing the width direction (e.g., X-axis direction) or the length direction (Y-axis direction) of the electronic device 200. The side surface may be defined by the base or the body of the electronic device 200, such as by the support unit 210, without being limited thereto.

In an embodiment, the electronic device 200 illustrated in FIGS. 2a, 2b, and 2c may be a portion of the constitution of another electronic device (e.g., the electronic device 101 of FIG. 1). For example, the electronic device 200 illustrated in FIGS. 2a, 2b, and 2c may mean a sound output module 155 (see FIG. 1) included in the electronic device 101 of FIG. 1. According to an embodiment, the electronic device 200 may be disposed inside the other electronic device 101 (see FIG. 1).

When an electronic device 200 according to an embodiment corresponds to a portion of the constitution of another electronic device 101 (see FIG. 1), some of the components of the electronic device 200 may include a portion of the components of the other electronic device 101 (see FIG. 1). For example, the cover 250 of the electronic device 200 illustrated in FIG. 2c may include a portion of a display (e.g., the display module 160 of FIG. 1) and/or a support bracket (not shown) of the other electronic device 101 (see FIG. 1).

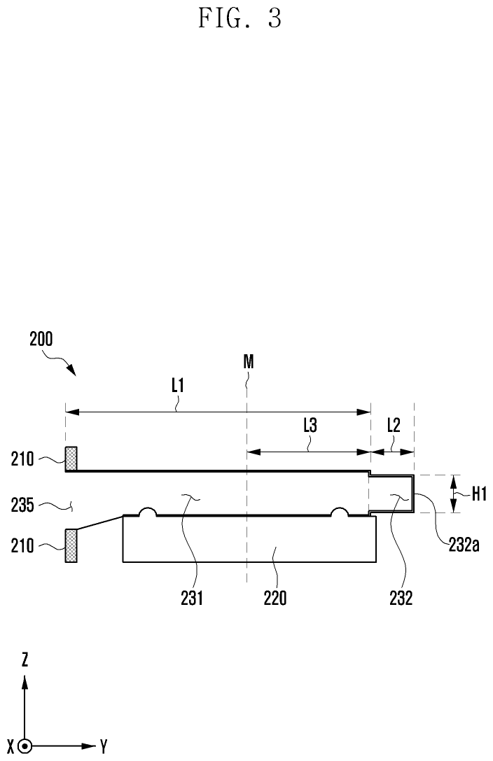

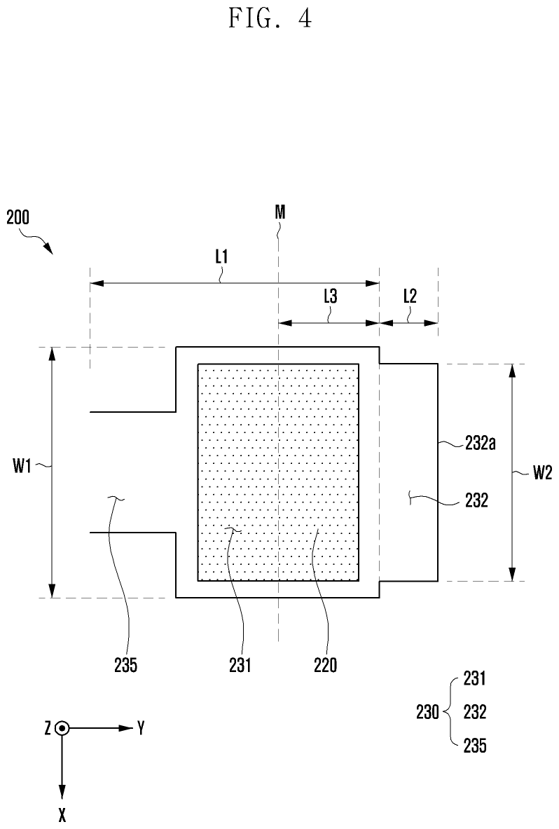

FIGS. 3 and 4 are cross-sectional side views illustrating a vibration unit 220 and a conduit unit 230 according to an embodiment of the present disclosure.

FIG. 3 may be a diagram illustrating a vibration unit 220 and a conduit unit 230 as viewed from the A-A′ cross-section of FIG. 2c (e.g., a cross-section perpendicular to the width direction of the electronic device 200). For example, FIG. 3 may be a conceptual diagram corresponding to the vibration unit 220 and the conduit unit 230 as viewed from the A-A′ cross-section of FIG. 2c.

FIG. 4 may be a diagram illustrating a vibration unit 220 and a conduit unit 230 as viewed from the B-B′ cross-section of FIG. 2c (e.g., a cross-section perpendicular to the height direction of the electronic device 200). For example, FIG. 4 may be a conceptual diagram corresponding to the vibration unit 220 and the conduit unit 230 as viewed from the B-B′ cross-section of FIG. 2c.

In an embodiment, the vibration unit 220 may be disposed to overlap at least a portion of the conduit unit 230. For example, with reference to FIGS. 3 and 4, the conduit unit 230 may be disposed in one surface direction of the vibration unit 220. For example, the conduit unit 230 may be disposed in the positive Z-axis direction with respect to the vibration unit 220.

With reference to FIG. 4, the conduit unit 230 is illustrated as being directly disposed on one surface of the vibration unit 220, but this is exemplary, and other constitutions may be disposed between the vibration unit 220 and the conduit unit 230. For example, at least a portion of the support unit 210 may be disposed between the vibration unit 220 and the conduit unit 230, and the vibration of the vibration unit 220 may be transmitted to the conduit unit 230 through the portion of the support unit 210.

In an embodiment, the conduit unit 230 may include a first tube 231, a second tube 232, and/or a radiation opening 235.

In an embodiment, the first tube 231 as a first sound conduit and the second tube 232 as a second sound conduit may include a space (or volume) through which sound generated from the vibration unit 220 moves within the body of the electronic device 200.

In an embodiment, a radiation opening 235 may be formed at one end of the conduit unit 230. For example, with reference to FIG. 3, the radiation opening 235 may be formed at the negative Y-axis direction end of the conduit unit 230. The radiation opening 235 may be open to outside the electronic device 200 and connect (e.g., audibly, fluidly, etc.) an inner area of the electronic device 200 to an outside thereof. The radiation opening 235 may connect the first tube 231 and the second tube 232 to the outside of the electronic device 200. An audio signal or sound may be output from the electronic device 200 in the negative Y-axis direction.

In an embodiment, one end of the first tube 231 may mean an end facing in the negative Y-axis direction in the first tube 231. The other end of the first tube 231 may mean an end facing in the positive Y-axis direction in the first tube 231. The first tube 231 may be open at opposing ends thereof along the Y-axis direction.

In an embodiment, the first tube 231 may be connected to a radiation opening 235 at one end.

In an embodiment, the first tube 231 may extend along the length direction (e.g., the Y-axis direction) of the electronic device 200. The first tube 231 may extend by a first length L1 in the length direction of the electronic device 200. The first tube 231 may extend by a first width W1 along the width direction (e.g., the X-axis direction) of the electronic device 200.

In an embodiment, the first tube 231 may be connected to the second tube 232. For example, the other end of the first tube 231 may be connected to the second tube 232.

In an embodiment, the second tube 232 may extend along the length direction (e.g., Y-axis direction) of the electronic device 200. The second tube 232 may extend by a second length L2 in a direction opposite to the direction in which the radiation opening 235 is located with respect to the first tube 231.

In an embodiment, the second tube 232 may be a closed tube having a closed end. For example, the end 232a of the second tube 232 facing opposite to the first tube 231 may be formed in a closed form.

In an embodiment, the center line M of the vibration unit 220 may mean an imaginary line which passes through a point located at the center in the length direction (e.g., Y-axis direction) of the vibration unit 220 and extends in the height direction (e.g., Z-axis direction). A third length L3 may be provided from the center line M of the vibration unit 220 to the other end of the first tube 231.

In an embodiment, the second length L2 may be determined on the basis of the first length L1 and the third length L3. For example, the second length L2 may be formed as a length within the range of [Equation 1].

$$\frac{L 1 - 3 \times L 3}{2} < L 2 < \frac{L 1 e - 3 \times L 3}{2} \qquad [ Equation 1 ]$$

In an embodiment, the first effective length (L1e) may be a length determined on the basis of the shape of the conduit unit 230 and/or the end correction effect by the radiation opening 235. For example, the first effective length (L1e) may be derived by [Equation 2].

$$L 1 e = \frac{3 \times c}{4 \times ( f\_peak )} \qquad [ Equation 2 ]$$

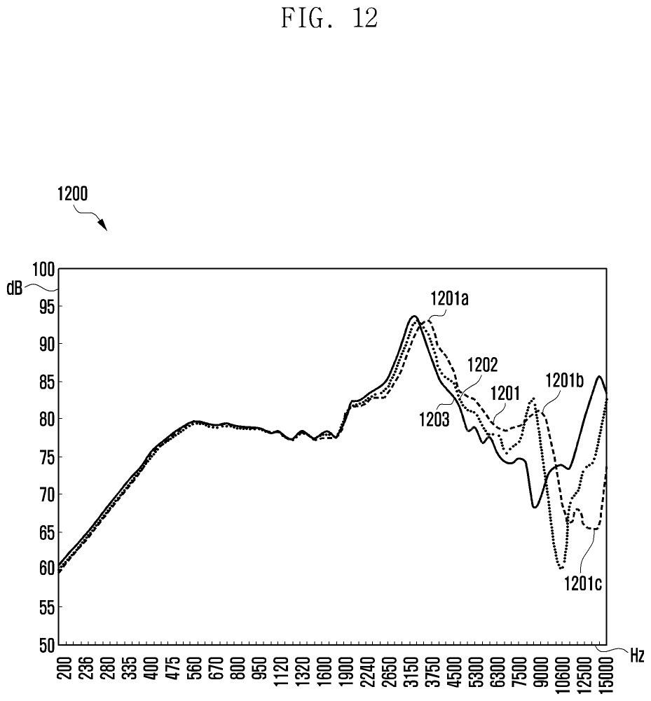

In [Equation 2], c may represent the sound speed of the medium, and f_peak may represent a second peak frequency measurement value. The sound speed (c) of the medium may represent the speed of sound in the medium (e.g., air) located inside the conduit unit 230. In [Equation 2], the second peak frequency measurement value (f_peak) may represent a measurement value of the frequency at which the second peak (e.g., 1201b) illustrated in FIG. 12 appears.

In an electronic device 200 according to an embodiment, when the second length L2 is formed to satisfy [Equation 1] and [Equation 2], the second peak 1201b (see FIG. 12) and/or the trough 1201c (see FIG. 12) in the graph 1200 illustrated in FIG. 12 may be eliminated, and the acoustic performance of the electronic device 200 may be improved.

In an embodiment, the second tube 232 may have a predetermined height and extend in the width direction (e.g., in the X-axis direction) of the electronic device 200. For example, the second tube 232 may have a first height H1 and extend in the width direction (e.g., in the X-axis direction) of the electronic device 200 by a second width W2.

In an embodiment, a maximum width of the first tube 231 may be formed to be greater than the maximum width of the second tube 232. For example, the first width W1 of the first tube 231 may be formed to be greater than the second width W2 of the second tube 632.

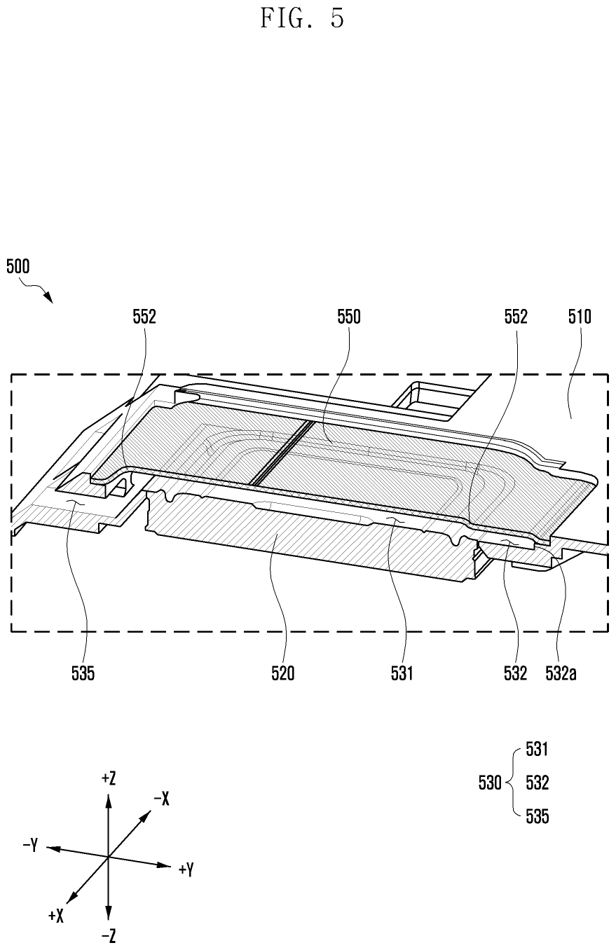

FIG. 5 is a diagram illustrating an electronic device 500 according to an embodiment of the present disclosure.

FIG. 5 may be a cross-sectional perspective view illustrating an electronic device 500 according to an embodiment of the present disclosure after being cut in a direction perpendicular to the width direction (e.g., X-axis direction) of the electronic device 500.

The electronic device 500 of FIG. 5 may be substantially identical to the electronic device 200 illustrated in FIGS. 2a, 2b, and 2c. For example, the electronic device 500 of FIG. 5 may mean the electronic device 200 of FIG. 2c, or may include at least a portion of the electronic device 200.

In an embodiment, the electronic device 500 may include a support unit 510, a vibration unit 520, a conduit unit 530, and/or a cover 550. The support unit 510, the vibration unit 520, the conduit unit 530, and the cover 550 of the electronic device 500 of FIG. 5 may have substantially the same functions as the support unit 210, the vibration unit 220, the conduit unit 230, and the cover 250 of FIGS. 2a, 2b, and 2c, respectively.

In describing an electronic device 500 according to an embodiment of the present disclosure, the width direction of the electronic device 500 may mean the X-axis direction, and the length direction of the electronic device 500 may mean the Y-axis direction. The height direction of the electronic device 500 may mean the Z-axis direction.

In an embodiment, the conduit unit 530 may include a first tube 531, a second tube 532, and/or a radiation opening 535.

In an embodiment, a radiation opening 535 may be disposed at one end of the first tube 531, and a second tube 532 may be disposed at the other end of the first tube 531.

In an embodiment, the second tube 532 may be a closed tube having a closed end. For example, with reference to FIG. 5, the end 532a of the second tube 532 may be formed in a closed form.

In an embodiment, the first tube 531 and the second tube 532 may be spaces or volumes surrounded by a support unit 510 and a cover 550.

In an embodiment, the heights of the first tube 531 and the second tube 532 may be formed differently. For example, the first tube 531 may be extended longer than the second tube 532 in the height direction (e.g., Z-axis direction) of the electronic device 500.

In an embodiment, the cover 550 may include a bending area 552 at which the cover 550 is bent. For example, the bending area 552 may be an area in which the cover 550 bends. In an embodiment, the bending area 552 may be formed at a distal end of the first tube 531. For example, the bending area 552 may be formed at a portion which overlaps a boundary between the first tube 531 and the second tube 532.

In an embodiment, the cover 550 may include a bending area 552 at a distal end of the first tube 531, such as at a portion which overlaps a boundary between the first tube 531 and the radiation opening 235.

In an embodiment, the bending area 552 of the cover 550 may be configured to secure a reinforcing structure (e.g., a stainless steel plate (not shown)) to one surface of the cover 550. For example, the reinforcing structure (not shown) may be disposed on one surface of the cover 550 (e.g., a surface facing the positive Z-axis direction) of the cover 550, and at least a portion of the reinforcing structure (not shown) may be secured to the bending area 552 to maintain a fixed position.

In FIG. 5, the cover 550 is illustrated as being bent and extended at least in a portion including a bending area 552, but this is exemplary, and the shape of the cover 550 may not be limited thereto. For example, the cover 550 may be formed to extend, without including a bending area 552 and without being bent, in a direction parallel to a plane which is substantially perpendicular to the height direction of the electronic device 500. When the cover 550 does not include a bending area 552 and extends parallel to a plane which is substantially perpendicular to the height direction of the electronic device 500, the first tube 531 and the second tube 532 may extend to substantially the same length on the basis of the height direction (e.g., Z-axis direction) of the electronic device 500. As extending to the same length, the first tube 531 and the second tube 532 may extend to a same plane.

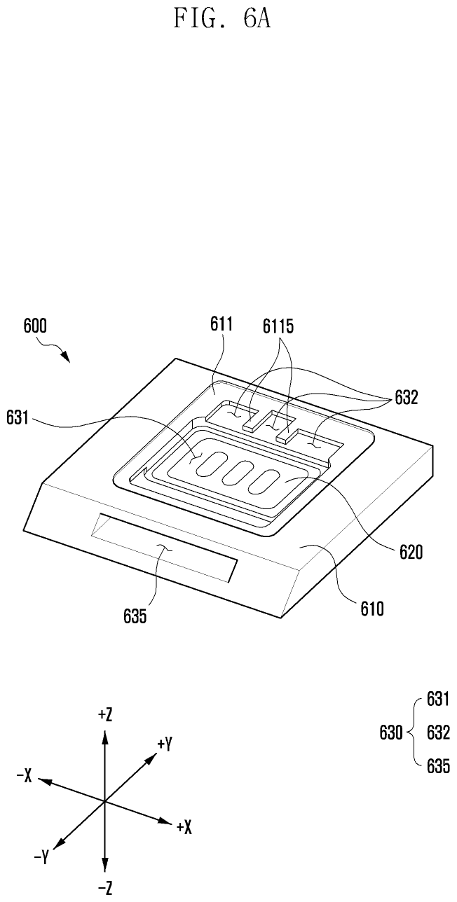

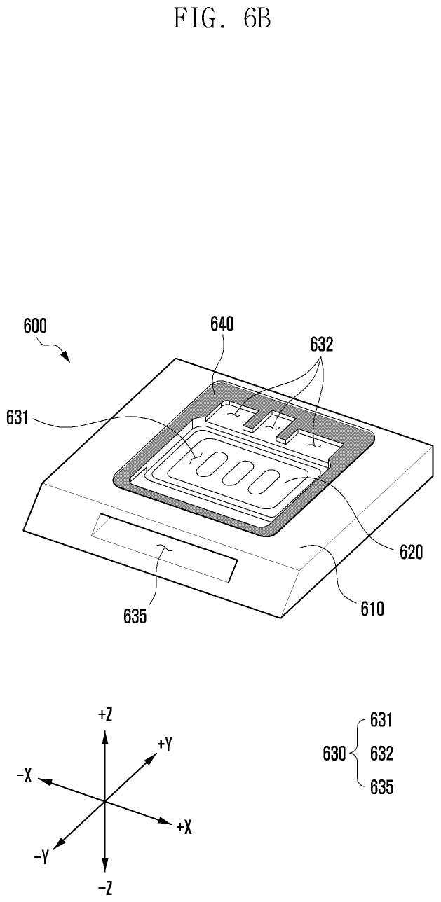

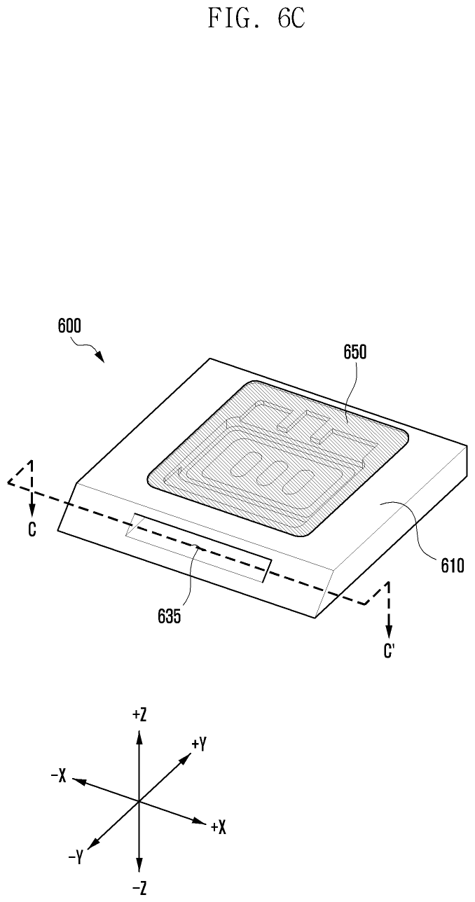

FIGS. 6a, 6b, and 6c are perspective views of an electronic device according to an embodiment of the present disclosure.

The electronic device 600 of FIGS. 6a, 6b, and 6c may include at least a portion of the electronic device 200 of FIG. 2c.

An electronic device 600 according to an embodiment of the present disclosure may include a support unit 610, a vibration unit 620, a conduit unit 630, an adhesive member 640, and/or a cover 650. The support unit 610, the vibration unit 620, the conduit unit 630, the adhesive member 640, and the cover 650 of the electronic device 600 of FIG. 6 may have substantially the same functions as the support unit 210, the vibration unit 220, the conduit unit 230, the adhesive member 240, and the cover 250 of FIGS. 2a, 2b, and 2c, respectively.

In describing an electronic device 600 according to an embodiment of the present disclosure, the width direction of the electronic device 600 may mean the X-axis direction, and the length direction of the electronic device 600 may mean the Y-axis direction. The height direction of the electronic device 600 may mean the Z-axis direction.

With reference to FIG. 6a, the vibration unit 620 may be disposed inside the support unit 610. For example, the vibration unit 620 may be at least partially surrounded by the support unit 610.

In an embodiment, the support unit 610 may include a seating unit 611. The seating unit 611 may be formed in a shape which surrounds the periphery of the vibration unit 620.

In an embodiment, the conduit unit 630 may include a first tube 631, a second tube 632, and/or a radiation opening 635.

With reference to FIG. 6a, the seating unit 611 according to an embodiment may include a partition wall 6115. The partition wall 6115 may be an area of the seating unit 611 extending in a direction toward the first tube 631. Here, solid (or material) portions of the seating unit 611 extend toward the first tube 631 in the negative Y-axis direction, and are spaced apart from each other along the width direction (e.g., the X-axis direction).

In an embodiment, the conduit unit 630 may include a plurality of second tubes 632. For example, with reference to FIG. 6a, the conduit unit 630 may include three second tubes 632. The plurality of second tubes 632 may be formed to be respectively separated from each other by a partition wall 6115. Each of the second tubes 632 may be open toward the first tube 631 at a first end of a second tube and closed at a second end opposite to the first end. Each of the second tubes 632 may be in communication with (e.g., connected to) a same first tube 631.

With reference to FIG. 6b, an adhesive member 640 may be disposed on the seating unit 611 of the support unit 610. The adhesive member 640 may serve to couple the cover 650 to the support unit 610.

With reference to FIG. 6c, a cover 650 may be disposed on a support unit 610. The cover 650 may be coupled to the support unit 610 by an adhesive member 640.

With reference to FIG. 6b, for example, the adhesive member 640 may also be disposed on the partition wall 6115 of the seating unit 611. When the adhesive member 640 is also disposed on the partition wall 6115, the cover 650 and the support unit 610 may be more strongly coupled compared to when the seating unit 611 does not include the partition wall 6115.

In an embodiment, the support unit 610 may further facilitate supporting the cover 650 by including the partition wall 6115. For example, the partition wall 6115 may serve to support at least a portion of the cover 650.

In an embodiment, at least a portion of the conduit unit 630 may be formed in the front direction of the vibration unit 620. The front direction of the vibration unit 620 may mean a direction facing the positive Z-axis direction in the vibration unit 620. In an embodiment, the conduit unit 630 may be a space through which sound generated from the vibration unit 620 is transmitted.

In an embodiment, the conduit unit 630 may be formed by the support unit 610 and the cover 650. For example, the conduit unit 630 may be a space at least partially surrounded by the vibration unit 620, the support unit 610, and the cover 650.

In an embodiment, the conduit unit 630 may include a radiation opening 635 at one end. Sound generated from the vibration unit 620 may be transmitted to the outside of the electronic device 600 through the radiation opening 635. In an embodiment, the radiation opening 635 may be formed on a side surface of the electronic device 600. The side surface of the electronic device 600 may be a surface facing the width direction (e.g., X-axis direction) or the length direction (Y-axis direction) of the electronic device 600.

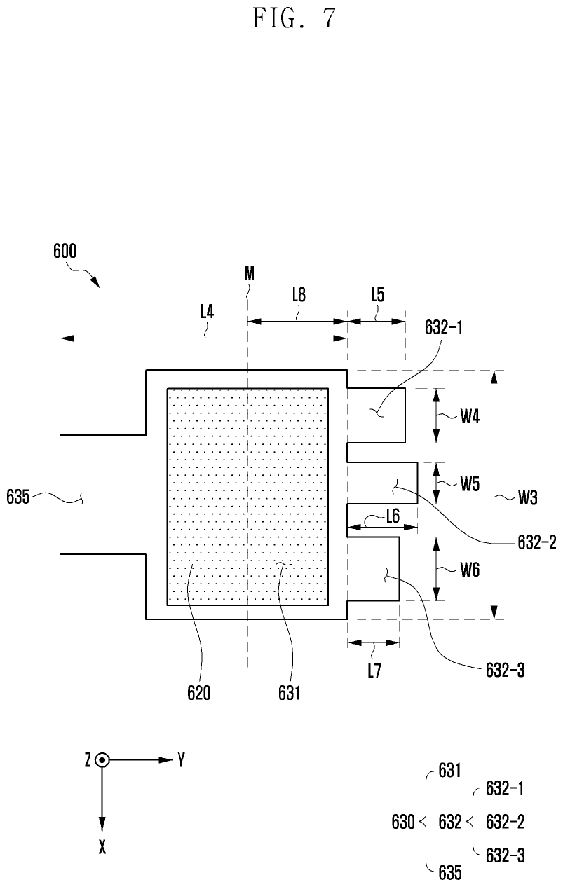

FIG. 7 is a plan view of a vibration unit 620 and a conduit unit 630 according to an embodiment of the present disclosure.

FIG. 7 may be a diagram illustrating a vibration unit 620 and a conduit unit 630 as viewed from the C-C′ cross-section of FIG. 6c. For example, FIG. 7 may be a conceptual diagram corresponding to the vibration unit 620 and the conduit unit 630 as viewed from the C-C′ cross-section of FIG. 6c.

With reference to FIG. 7, the conduit unit 630 according to an embodiment may include a first tube 631, a second tube 632, and/or a radiation opening 635.

In an embodiment, the first tube 631 may extend in the length direction (e.g., Y-axis direction) of the electronic device 600 by a fourth length L4. The first tube 631 may extend in the width direction of the electronic device 600 by a third width W3.

In an embodiment, the radiation opening 635 may be formed at one end of the first tube 631, and the second tube 632 may be formed at the other end of the first tube 631. In an embodiment, the second tube 632 may be formed at a position spaced apart from the center line M of the vibration unit 620 by an eighth length L8.

In an embodiment, the conduit unit 630 may include a plurality of second tubes 632. For example, the plurality of second tubes 632 may be spaced apart from each other in the width direction of the electronic device 600.

In an embodiment, the second tube 632 may include a second-first tube 632-1, a second-second tube 632-2, and/or a second-third tube 632-3. The second-first tube 632-1, the second-second tube 632-2, and/or the second-third tube 632-3 may be referred to as a sub-tube or a sub-sound conduit of the second tuber 632.

In an embodiment, the second-first tube 632-1 may have a fifth length L5 and a fourth width W4. The second-second tube 632-2 may have a sixth length L6 and a fifth width W5. The second-third tube 632-3 may have a seventh length L7 and a sixth width W6.

In an embodiment, the fifth length L5 of the second-first tube 632-1, the sixth length L6 of the second-second tube 632-2, and the seventh length L7 of the second-third tube 632-3 may be determined on the basis of the fourth length L4 and the eighth length L8, respectively.

In an embodiment, the lengths and widths of the plurality of second tubes 632 may be formed in various ways. For example, the fifth length L5 of the second-first tube 632-1, the sixth length L6 of the second-second tube 632-2, and the seventh length L7 of the second-third tube 632-3 may be formed differently. For example, the fourth width W4 of the second-first tube 632-1, the fifth width W5 of the second-second tube 632-2, and the sixth width W6 of the second-third tube 632-3 may be formed differently.

In an embodiment, a maximum width of the first tube 631 may be formed to be greater than the sum of the widths of each of the plurality of second tubes 632. For example, the third width W3 of the first tube 631 may be formed to be greater than the sum of the fourth width W4 of the second-first tube 632-1, the fifth width W5 of the second-second tube 632-2, and the sixth width W6 of the second-third tube 632-3.

In an embodiment, the (audio) reflection coefficient of the second tube 632 may vary on the basis of the relative ratio of the sum of the fourth width W4, the fifth width W5, and the sixth width W6 to the third width W3. For example, the trough (e.g., 1201c) of the graph 1200 illustrated in FIG. 12 may vary on the basis of the value obtained by dividing the sum of the fourth width W4, the fifth width W5, and the sixth width W6 by the third width W3.

With reference to FIG. 7, on a plane substantially perpendicular to the height direction of the electronic device 600, each of the plurality of sub-tubes is illustrated as having a rectangular cross-section (e.g., a rectilinear planar shape). However, this is exemplary, and the cross-section of the sub-tubes may not be limited thereto. For example, on a plane substantially perpendicular to the height direction of the electronic device 600, each of the plurality of sub-tubes may be formed to have a cross-section (e.g., a planar shape) which extends in a curved shape at least in a portion.

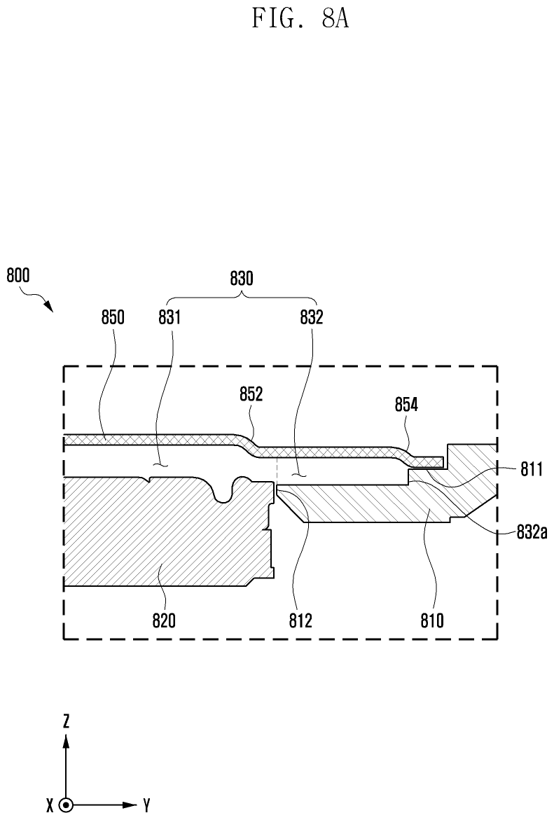

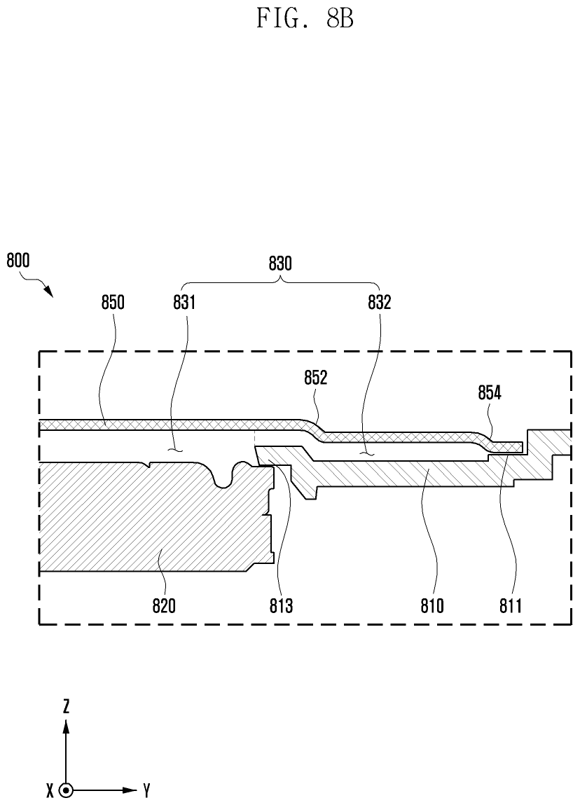

FIGS. 8a and 8b are cross-sectional side views of an electronic device 800 according to an embodiment of the present disclosure.

The electronic device 800 of FIGS. 8a and 8b may be substantially identical to or similar to the electronic device 200 illustrated in FIG. 2c. For example, the electronic device 800 of FIGS. 8a and 8b may mean the electronic device 200 of FIG. 2c or may include at least a portion of the electronic device 200 of FIG. 2c.

In describing an electronic device 800 according to an embodiment of the present disclosure, the width direction of the electronic device 800 may mean the X-axis direction, and the length direction of the electronic device 800 may mean the Y-axis direction. The height direction of the electronic device 800 may mean the Z-axis direction.

FIGS. 8a and 8b may be conceptual diagrams illustrating an electronic device 800 according to an embodiment, in a cross-section perpendicular to the width direction (e.g., X-axis direction) of the electronic device 800. For example, FIGS. 8a and 8b may be conceptual diagrams illustrating a cross-section of the electronic device 800 corresponding to the A-A′ cross-section of the electronic device 200 of FIG. 2c.

With reference to FIGS. 8a and 8b, an electronic device 800 according to an embodiment may include a support unit 810, a vibration unit 820, a conduit unit 830, and/or a cover 850. The support unit 810, the vibration unit 820, the conduit unit 830, and the cover 850 of the electronic device 800 illustrated in FIGS. 8a and 8b may have substantially the same functions as the support unit 210, the vibration unit 220, the conduit unit 230, and the cover 250 of FIGS. 2a, 2b, and 2c, respectively.

In an embodiment, the conduit unit 830 may be formed by a vibration unit 820, a support unit 810, and a cover 850. For example, the conduit unit 830 may be a space which is at least partially surrounded by the vibration unit 820, the support unit 810, and the cover 850.

In an embodiment, a cover 850 may be disposed in one direction (e.g., positive Z-axis direction) with respect to the conduit unit 830, and a vibration unit 820 and a support unit 810 may be disposed in the other direction (e.g., negative Z-axis direction).

In an embodiment, the conduit unit 830 may include a first tube 831 and/or a second tube 832. The first tube 831 and the second tube 832 may extend along the length direction (e.g., the Y-axis direction) of the electronic device 800. The first tube 831 may be connected to a radiation opening 235 (see FIG. 3) at one end and connected to a second tube 832 at the other end. The second tube 832 may be connected to the first tube 831 and may be formed in a closed shape at an end 832a.

In an embodiment, the cover 850 may include bending areas 852 and 854. The bending areas 852 and 854 may be an area or position along the cover 850 at which the cover 850 is bent. In an embodiment, the bending areas 852 and 854 may include a first bending area 852 and a second bending area 854.

In an embodiment, the first bending area 852 may be formed at a position overlapping the distal end of the first tube 831 (e.g., the distal end from the first tube 831 toward the second tube 832). The cover 850 may be bent and extended at the first bending area 852 so that the height (e.g., the length in the Z-axis direction) of the second tube 832 may be formed to be smaller than the height of the first tube 831. Here, the cover 850 may include a first step at a boundary between the first tube 831 and the second tube 832 to reduce a space or volume of the second tube 832.

In an embodiment, the second bending area 854 may be formed at a position overlapping the end 832a of the second tube 832. The cover 850 may extend further than the end 832a, in the positive Y-axis direction, to define an extended portion of the cover 850 which overlaps the support unit 810. For example, the support unit 810 may include a support surface 811 at which the extended portion of the cover 850 is attached to (or seated on) the support unit 810.

In an embodiment, one surface of the vibration unit 820 may mean a surface of the vibration unit 820 which faces the conduit unit 830. In an embodiment, the side surface of the vibration unit 820 may mean a surface which is substantially perpendicular to the height direction (e.g., Z-axis direction) of the electronic device 800 in the vibration unit 820.

With reference to FIG. 8a, the coupling surface 812 of the support unit 810 according to an embodiment may be formed to face the side surface of the vibration unit 820.

With reference to FIG. 8b, the support unit 810 according to an embodiment may include a fixed area 813. For example, the fixed area 813 may be an area in which an extended portion of the support unit 810 extends to face one surface of the vibration unit 820. In an embodiment, when the support unit 810 includes the fixed area 813, the support unit 810 may be more strongly coupled to the vibration unit 820.

With reference to FIG. 8a, a support unit 810 according to an embodiment may not include a fixed area 813 and may be coupled to a vibration unit 820 at the coupling surface 812. When the support unit 810 according to an embodiment does not include a separate fixed area 813, the thickness of the support unit 810 (e.g., the length by which the support unit 810 extends in the Z-axis direction) may be formed relatively thin.

In an embodiment, a support unit 810 may be disposed in a lateral direction (e.g., in the positive Y-axis direction) of the vibration unit 820.

In an embodiment, the vibration unit 820 and the support unit 810 may be bonded to each other at least in part. For example, with reference to FIG. 8a, the coupling surface 812 of the support unit 810 may be bonded to a side surface of the vibration unit 820 using a separate adhesive member (e.g., bond, double-sided tape). With reference to FIG. 8b, the fixing area 813 of the support unit 810 may be bonded to one surface of the vibration unit 820 using a separate adhesive member (e.g., bond, double-sided tape).

With reference to FIG. 8b, a recess may be formed by a stepped portion of the fixed area 813 and the support surface 811 relative to an upper surface of the support unit 810 at the second tube 832. The recess of the support unit 810 which faces the cover 850 may define the second tube 832 therebetween.

In an embodiment, the vibration unit 820 and the support unit 810 may be bonded to each other at least in part, and the space between the vibration unit 820 and the support unit 810 may be sealed. As the space between the vibration unit 820 and the support unit 810 is sealed, sound generated from the vibration unit 820 may travel along the conduit unit 830 and be transmitted to the outside of the electronic device 800 through the radiation opening 235 (see FIG. 3).

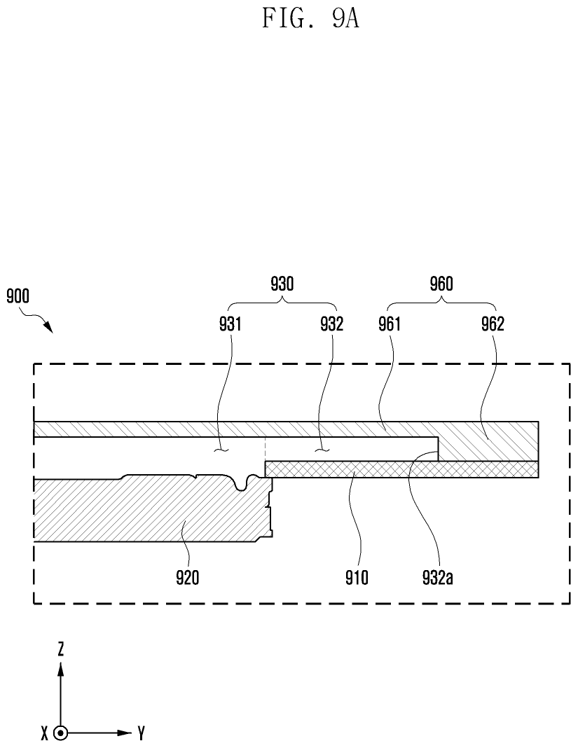

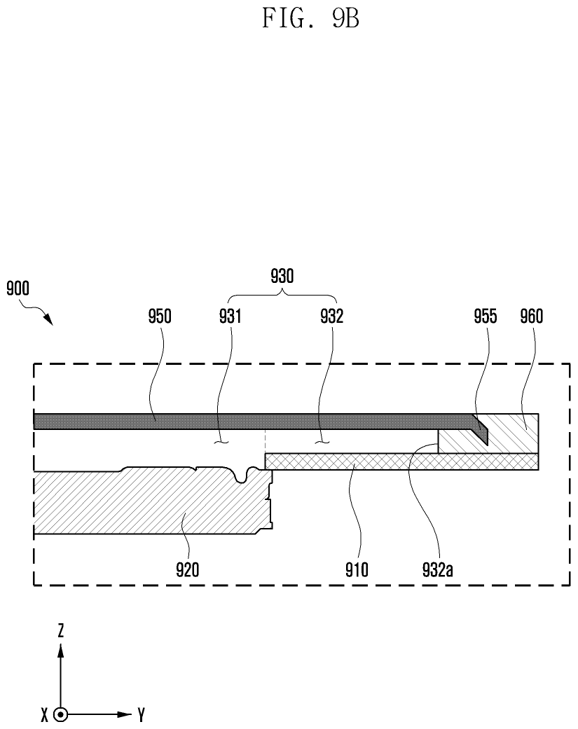

FIGS. 9a and 9b are perspective views of an electronic device 900 according to an embodiment of the present disclosure.

The electronic device 900 of FIGS. 9a and 9b may be substantially identical to or similar to the electronic device 200 illustrated in FIG. 2c. For example, the electronic device 900 of FIGS. 9a and 9b may mean the electronic device 200 of FIG. 2c or may include at least a portion of the electronic device 200 of FIG. 2c.

In describing an electronic device 900 according to an embodiment of the present disclosure, the width direction of the electronic device 900 may mean the X-axis direction, and the length direction of the electronic device 900 may mean the Y-axis direction. The height direction of the electronic device 900 may mean the Z-axis direction.

FIGS. 9a and 9b may be conceptual diagrams illustrating an electronic device 900 according to an embodiment, in a cross-section perpendicular to the width direction (e.g., X-axis direction) of the electronic device 900. For example, FIGS. 9a and 9b may be conceptual diagrams illustrating a cross-section of the electronic device 900 corresponding to the A-A′ cross-section of the electronic device 200 of FIG. 2c.

With reference to FIG. 9a, an electronic device 900 according to an embodiment may include a first support unit 910, a vibration unit 920, a conduit unit 930, and/or a second support unit 960.

With reference to FIG. 9a, a conduit unit 930 according to an embodiment may be formed by a vibration unit 920, a first support unit 910 as a support body, and a second support unit 960 as a cover body (or cover). For example, the conduit unit 930 may be a space which is at least partially surrounded by the vibration unit 920, the first support unit 910, and the second support unit 960.

With reference to FIG. 9a, a second support unit 960 according to an embodiment may include a cover area 961 and/or a support area 962. The cover area 961 may be an area which covers the conduit unit 930 and extends in a direction substantially perpendicular to the height direction (e.g., Z-axis direction) of the electronic device 900. With reference to FIG. 9b, the support area 962 may be an area which is connected to the cover area 961 and extends in the height direction (e.g., Z-axis direction) of the electronic device 900. The support area 962 may be disposed on one surface of the first support unit 910.

With reference to FIG. 9a, in an embodiment, a cover area 961 may be disposed in one direction (e.g., positive Z-axis direction) with respect to the second tube 932 of the conduit unit 930, and a vibration unit 920 and/or a first support unit 910 may be disposed in the other direction (e.g., negative Z-axis direction) with respect to the second tube 932 of the conduit unit 930.

With reference to FIG. 9b, an electronic device 900 according to an embodiment may include a first support unit 910, a vibration unit 920, a conduit unit 930, a cover 950, and/or a second support unit 960.

With reference to FIG. 9b, a conduit unit 930 according to an embodiment may be formed by a vibration unit 920, a first support unit 910 as a first support body, a cover 950, and a second support unit 960 as a second support body. For example, the conduit unit 930 may be a space which is at least partially surrounded by the vibration unit 920, the first support unit 910, the cover 950, and the second support unit 960.

With reference to FIG. 9b, a support unit 960 according to an embodiment may be formed separately from the cover 950. For example, the second support unit 960 may be formed separately from the cover 950 and then coupled to the cover 950 at an end of the second tube 932. The second support unit 960 may be disposed on one surface of the first support unit 910.

With reference to FIG. 9b, a cover 950 according to an embodiment may include a connection area 955 at a distal end. The connection area 955 may be an area extending in an inclined direction from a surface of the cover 950 (e.g., a surface perpendicular to the Z-axis direction of the cover 950) at the distal end of the cover 950. For example, the second support unit 960 and the cover 950 may be more strongly coupled through the connection area 955.

With reference to FIG. 9b, in an embodiment, a cover 950 may be disposed in one direction (e.g., positive Z-axis direction) with respect to the conduit unit 930, and a vibration unit 920 and a first support unit 910 may be disposed in the other direction (e.g., negative Z-axis direction).

With reference to FIGS. 9a and 9b, in an embodiment, the conduit unit 930 may include a first tube 931 and/or a second tube 932. The first tube 931 and the second tube 932 may extend along the length direction (e.g., the Y-axis direction) of the electronic device 900. The first tube 931 may be connected to a radiation opening 235 (see FIG. 3) at one end and connected to the second tube 932 at the other end. The second tube 932 may be connected to the first tube 931 and may be formed in a closed shape at an end 932a.

With reference to FIGS. 9a and 9b, the end 932a of the second tube 932 may be formed by the second support unit 960. For example, the second tube 932 may be formed in a closed form at the end 932a by the second support unit 960.

In an embodiment, the first support unit 910 of FIGS. 9a and 9b may include stainless steel (STS). For example, stainless steel (STS) may be processed to form a shape of the first support unit 910.

In an embodiment, the second support unit 960 of FIGS. 9a and 9b may include a resin material. For example, the resin material may be processed through injection molding to form the second support unit 960.

In an embodiment, the cover 950 of FIG. 9b may include stainless steel (STS). For example, stainless steel (STS) may be processed to form the cover 950. In an embodiment, when the cover 950 of the electronic device 900 includes stainless steel, the thickness of the cover 950 may be formed relatively thin.

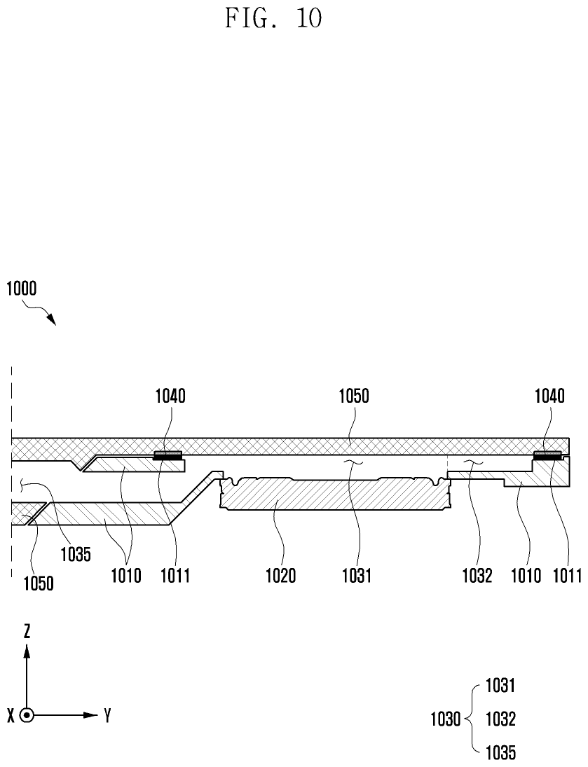

FIG. 10 is a cross-sectional side view of an electronic device 1000 according to an embodiment of the present disclosure.

The electronic device 1000 of FIG. 10 may be substantially identical to or similar to the electronic device 200 illustrated in FIG. 2c. For example, the electronic device 1000 of FIG. 10 may mean the electronic device 200 of FIG. 2c or may include at least a portion of the electronic device 200 of FIG. 2c.

In describing an electronic device 1000 according to an embodiment of the present disclosure, the width direction of the electronic device 1000 may mean the X-axis direction, and the length direction of the electronic device 1000 may mean the Y-axis direction. The height direction of the electronic device 1000 may mean the Z-axis direction.

FIG. 10 may be a conceptual diagram illustrating an electronic device 1000 according to an embodiment of the present disclosure in a cross-section perpendicular to the width direction (e.g., X-axis direction) of the electronic device 1000. For example, FIG. 10 may be a conceptual diagram illustrating a cross-section of the electronic device 1000 corresponding to the A-A′ cross-section of the electronic device 200 of FIG. 2c.

With reference to FIG. 10, an electronic device 1000 according to an embodiment may include a support unit 1010, a vibration unit 1020, a conduit unit 1030, an adhesive member 1040, and/or a cover 1050. The support unit 1010, the vibration unit 1020, the conduit unit 1030, the adhesive member 1040, and the cover 1050 of the electronic device 1000 illustrated in FIG. 10 may have substantially the same functions as the support unit 210, the vibration unit 220, the conduit unit 230, the adhesive member 240, and the cover 250 of FIGS. 2a, 2b, and 2c, respectively.

With reference to FIG. 10, a conduit unit 1030 according to an embodiment may be formed by a vibration unit 1020, a supporting section 1010, and a cover 1050. For example, the conduit unit 1030 may be a space which is at least partially surrounded by the vibration unit 1020, the supporting section 1010, and the cover 1050. That is, inner surfaces of these components may be exposed to the conduit unit 1030 such as to form the various volumes of the conduit unit 1030. In an embodiment, the conduit unit 1030 may include a first tube 1031, a second tube 1032 and/or a radiation opening 1035.

With reference to FIG. 10, in an embodiment, a cover 1050 may be disposed in one direction (e.g., positive Z-axis direction) with respect to a conduit unit 1030, and a vibration unit 1020 may be disposed in the other direction (e.g., negative Z-axis direction). Here, the cover 1050 and the vibration unit 1020 may face each other with the conduit unit 1030 therebetween.

With reference to FIG. 10, the cover 1050 may be coupled to at least a portion of the support 1010 through an adhesive member 1040. The support 1010 may include a seating unit 1011 on which the adhesive member 1040 is disposed. The adhesive member 1040 may be disposed on the seating unit 1011 of the support 1010 and may couple the cover 1050 and the support 1010 to each other.

In an embodiment, the cover 1050 may be a constitution having a function other than forming the conduit unit 1030. For example, the cover 1050 may include a display (e.g., a display module 160, see FIG. 1) included in the electronic device 1000. When the cover 1050 includes a display, the cover 1050 may serve to visually display information to the outside of the electronic device 1000.

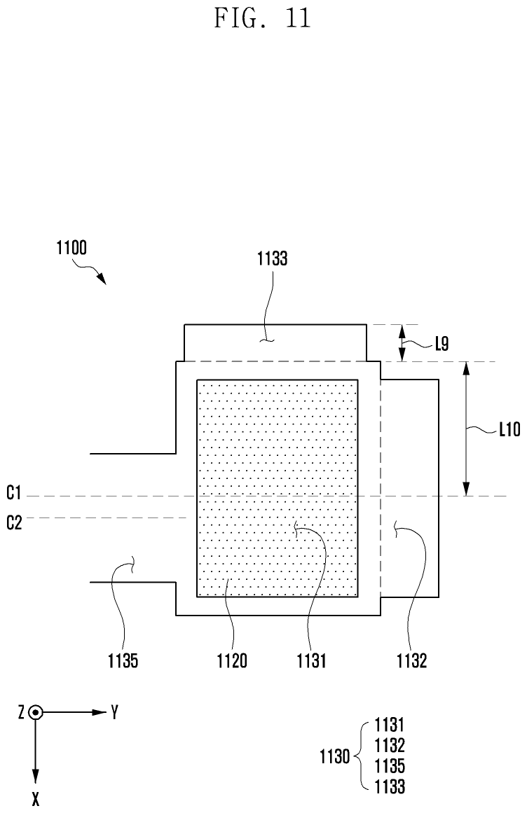

FIG. 11 is a plan view of an electronic device 1100 according to an embodiment of the present disclosure.

The electronic device 1100 of FIG. 11 may be substantially the same as or similar to the electronic device 200 illustrated in FIG. 4. For example, the electronic device 1100 of FIG. 11 may mean the electronic device 200 of FIG. 4 or may include at least a portion of the electronic device 200 of FIG. 4.

In describing an electronic device 1100 according to an embodiment of the present disclosure, the width direction of the electronic device 1100 may mean the X-axis direction, and the length direction of the electronic device 1100 may mean the Y-axis direction. The height direction of the electronic device 1100 may mean the Z-axis direction.

FIG. 11 may be a conceptual diagram illustrating an electronic device 1100 according to an embodiment, in a cross-section perpendicular to the height direction (e.g., Z-axis direction) of the electronic device 1100. For example, FIG. 11 may be a conceptual diagram illustrating a cross-section of the electronic device 1100 corresponding to the B-B′ cross-section of the electronic device 200 of FIG. 2c.

In an embodiment, the electronic device 1100 may include a vibration unit 1120 and/or a conduit unit 1130.

In an embodiment, the conduit unit 1130 may include a first tube 1131, a second tube 1132, a third tube 1133, and/or a radiation opening 1135.

In an embodiment, the vibration unit 1120 may be disposed to overlap the first tube 1131. As being overlapping, elements may be disposed along a same line in a direction, such as along a thickness direction, a lateral direction, a planar direction, etc. For example, one element may be above or below another element along a thickness (or height) direction, so as to be be considered overlapping each other, without being limited thereto.

In an embodiment, the first center line C1 may mean a line passing through the center of the vibration unit 1120 (e.g., the center of the X-axis direction of the vibration unit 1120) along a direction parallel to the length direction (e.g., the Y-axis direction) of the electronic device 1100.

In an embodiment, the second center line C2 may mean a line passing through the center of the radiation opening 1135 (e.g., the center of the radiation opening 1135 in the X-axis direction) along a direction parallel to the length direction (e.g., the Y-axis direction) of the electronic device 1100.

In an embodiment, the third tube 1133 as a third sound conduit may be formed to extend in a direction substantially perpendicular to the direction in which the second tube 1132 extends. For example, with reference to FIG. 11, the second tube 1132 may extend in the Y-axis direction, and the third tube 1133 may extend in the X-axis direction.

In an embodiment, when the first center line C1 and the second center line C2 do not coincide, the shape of the conduit unit 1130 may not be formed symmetrically with respect to the widthwise center line (e.g., the first center line C1) of the vibration unit 1120.

In an embodiment, when the first center line C1 and the second center line C2 do not coincide, the third tube 1133 may extend from the first tube 1131 in an opposite direction to the direction in which the second center line C2 is located with respect to the first center line C1. For example, with reference to FIG. 11, since the second center line C2 is located in the positive X-axis direction with respect to the first center line C1, the third tube 1133 may extend from the first tube 1131 in the negative X-axis direction.

In an embodiment, the third tube 1133 may extend from the first tube 1131 by a ninth length L9. In an embodiment, the distance from the center of the vibration unit 1120 to an end of the first tube 1131 (e.g., an end facing the negative X-axis direction of the first tube 1131) may have a tenth length L10.

When the first center line C1 and the second center line C2 do not coincide, sound waves reflected from one side of the conduit unit 1130 (e.g., the side surface located in the positive X-axis direction of the conduit unit 1130) and the other side (e.g., the side surface located in the negative X-axis direction of the conduit unit 1130) may be difficult to cancel each other out. The electronic device 1100 according to an embodiment may include a third tube 1133 to allow sound waves reflected from one side and the other side of the conduit unit 1130 to cancel each other out, when the first center line C1 and the second center line C2 do not coincide.

FIG. 12 is a graph illustrating the sound pressure level of an electronic device 200 according to an embodiment of the present disclosure.

The horizontal axis of the graph 1200 illustrated in FIG. 12 may represent the frequency (e.g., hertz (Hz)) of the vibration unit 220 of the electronic device 200. The vertical axis of the graph illustrated in FIG. 12 may represent the sound pressure level (SPL) (e.g., decibel (dB)) generated from the vibration unit 220.

The graph 1200 of FIG. 12 may include a first measurement line 1201, a second measurement line 1202, and a third measurement line 1203. The first measurement line 1201 may mean a sound pressure level measurement value when the second length L2 of the second tube 232 in the electronic device 200 is formed relatively small. The third measurement line 1203 may mean a sound pressure level measurement value when the second length L2 of the second tube 232 in the electronic device 200 is formed relatively long. For example, the third measurement line 1203 may represent a sound pressure level value measured in an electronic device 200 in which the second length L2 is formed longer compared to an electronic device 200 corresponding to the second measurement line 1202. The second measurement line 1202 may represent a sound pressure level value measured in an electronic device 200 having a second length L2 formed longer compared to the electronic device 200 corresponding to the first measurement line 1201.

In an embodiment, on the basis of the second length L2 of the second tube 232 of the electronic device 200, the measured value of the sound pressure level corresponding to the frequency (e.g., hertz (Hz)) of the vibration unit 220 may vary.

In an embodiment, the peaks 1201a and 1201b of the first measurement line 1201 may mean measurement values of local peaks of the first measurement line 1201. The first measurement line 1201 may include the first peak 1201a and/or the second peak 1201b. For example, with reference to FIG. 12, the first peak 1201a and the second peak 1201b may have relatively high values compared to other areas of the first measurement line 1201.

In an embodiment, the trough 1201c of the first measurement line 1201 may mean a measurement value of a local trough of the first measurement line 1201. With reference to FIG. 12, the trough 1201c may have a relatively low value compared to other areas of the first measurement line 1201.

In an embodiment, the first peak 1201a and the second peak 1202b may vary on the basis of the sum of the first length L1 (see FIG. 3) and the second length L2 (see FIG. 3) of the electronic device 200.

In an embodiment, the trough 1201c may vary on the basis of the sum of the second length L2 (see FIG. 3) and the third length L3 (see FIG. 3) of the electronic device 200.

In an embodiment, the second peak 1201b and the trough 1201c of the first measurement line 1201 may change according to a change in the second length L2 of the electronic device 200. In an embodiment, as the second length L2 of the electronic device 200 increases, the measurement lines 1201, 1202, and 1203 corresponding to the electronic device 200 may change in the order of the first measurement line 1201, the second measurement line 1202, and the third measurement line 1203. For example, the third measurement line 1203 corresponding to the electronic device 200 in which the second length L2 of the electronic device 200 is formed relatively long may be formed in a shape in which the second peak 1201b and the trough 1201c are eliminated from the first measurement line 1201.

With reference to FIG. 12, the sound pressure level of the third measurement line 1203 may change with a relatively more uniform value according to the change in frequency compared to the second measurement line 1202 and the first measurement line 1201. For example, since the third measurement line 1203 is formed in a shape in which the second peak 1201b and the trough 1201c are eliminated from the first measurement line 1201, the sound pressure level may change with a relatively more uniform value according to the change in frequency.

In an embodiment, a measured sound pressure level of the electronic device 200 includes a sound speed of air located inside the sound conduit (e.g., the conduit unit 230) and a peak of sound pressure generated from the vibration generator (e.g., the vibration unit 220), when the sound conduit has a minimum second length (like in the first measurement line 1201 described above). In the Equations detailed above, a first effective length Le1 of the sound conduit is derived from a shape of the sound conduit, and the second length L2 of an electronic device 200 where a peak and/or a trough is reduced or effectively eliminated, is further derived based on the first length L1, the third length L3 and the first effective length L1e. In such case, the second length L2 satisfies Equation 1, while the first effective length L1e satisfies Equation 2. In the Equations, ‘c’ represents the sound speed of air and ‘f_peak” represents a frequency of the vibration generator 220 which corresponds to the peak of sound pressure from the measured sound pressure level of the electronic device 200.

An electronic device 200 according to an embodiment of the present disclosure includes a vibration unit 220 for generating a sound, and a conduit unit 230 which is formed on the front surface of the vibration unit 220, and which is the space through which the sound generated by the vibration unit 220 is transmitted, where the conduit unit 230 includes a radiation opening 235 for transmitting the sound to the outside of the electronic device, a first tube 231, which is connected to the radiation opening 235 at one end thereof and extends a first length L1, and a second tube 232, which is connected to the first tube 231 at the other end of the first tube 231, extends a second length L2 in the direction opposite to that of the radiation opening 235, and is shaped to have a closed end.

Here, an electronic device 200 includes a vibration generator (like 220) which generates a sound, the vibration generator having a center in a first direction (e.g., a positive Y-axis direction), and a sound conduit (like 230) through which the sound generated by the vibration generator is transmitted, the sound conduit on a front surface of the vibration generator. The sound conduit includes a radiation opening (like 235) of the electronic device through which the sound is transmitted to outside of the electronic device from the sound conduit, a first sound conduit (like 231) which is connected to the radiation opening at a first end of the first sound conduit, and a second sound conduit (like 232) which is connected to the first sound conduit at a second end of the first sound conduit which is opposite to the first end, the second sound conduit having a closed end (like 232a) opposite to the first sound conduit, the first sound conduit extending a first length L1 in the first direction from the radiation opening, the second sound conduit extending a second length L2 in the first direction from the second end of the first sound conduit, and the first sound conduit extending a third length L3 in the first direction from the center (like M) of the vibration generator to the second end of the first conduit. The second length is derived based on the first length and the third length, such as by using the measured sound pressure level of the electronic device 200 describe above.

In an embodiment, the second length L2 may be determined on the basis of the first length L1 and the third length L3, which is the length from the center of the vibration unit 220 to the other end of the first tube 231.

In an embodiment, the second length L2 is determined on the basis of the first length L1, the third length L3 and the first effective length Lie, and the first effective length Lie may be determined on the basis of the shape of the conduit unit 230.

In an embodiment, the width of the second tube 232 may be formed smaller than the width of the first tube 231.

In an embodiment, the electronic device 600 may include a plurality of second tubes 632, and the plurality of second tubes 632 may be spaced apart from each other in the width direction of the electronic device 600. For example, the second sound conduit includes a plurality of sub-sound conduits (like 632) arranged spaced apart from each other in a second direction (e.g., the X-axis direction) crossing the first direction.

In an embodiment, the plurality of second tubes 632 may be formed with different widths.

In an embodiment, the sum of the widths of each of the plurality of second tubes 632 may be formed to be smaller than the width of the first tube 631.

In an embodiment, the second tube 232 may have a length determined in the height direction of the second tube 232 and may extend in the width direction of the second tube 232. For example, the second sound conduit (like 232) has a major dimension (e.g., the length) extended along a second direction (e.g., the X-axis direction) crossing the first direction.

In an embodiment, the electronic device 200 may include a cover 250 disposed spaced apart from the vibration unit 220 with a first tube 231 interposed therebetween and a support unit 210 surrounding the vibration unit 220, and the second tube 232 may be a space formed by the cover 250 and the support unit 210. For example, the electronic device 200 may further include a support body (like 210) in which the vibration generator is disposed, the support body surrounding the vibration generator, and a cover 250 which faces the vibration generator with the first sound conduit therebetween and faces the support body with the second sound conduit therebetween.

In an embodiment, the electronic device 200 may include an adhesive member 240 disposed on a support unit 210, and the cover 250 may be coupled to the support unit 210 using the adhesive member 240.

In an embodiment, the cover 1050 may be a display which visually displays information to the outside of the electronic device 1000.

In an embodiment, the support unit 810 may include a fixed area 813, which may be an area where a portion of the support unit 810 extends to face one surface of the vibration unit 820. For example, the support body (like 210) may include a portion which overlaps the front surface of the vibration generator at a fixed area 813 of the support body.

In an embodiment, the electronic device 900 may include a second support unit 960 including a cover area 961 disposed in an opposite direction to the first support unit 910 with respect to the first support unit 910 and the second tube 932, where the first support unit 910 includes stainless steel, and the conduit unit 930 may be a space at least partially surrounded by the vibration unit 920, the first support unit 910, and the second support unit 960. For example, the electronic device 900 may include a support body (like 910) in which the vibration generator is disposed, and a cover (like 960) including a cover area 961 facing the support body with the second sound conduit (like 932) therebetween.

In an embodiment, the electronic device 900 may include a first support unit 910, a cover 950 disposed in an opposite direction to the first support unit 910 with respect to a second tube 932, and a second support unit 960 coupled to the cover 950 and disposed on one surface of the first support unit 910, where the first support unit 910 and the cover 950 include stainless steel, and the conduit unit 930 may be a space at least partially surrounded by the vibration unit 920, the first support unit 910, the cover 950, and the second support unit 960. For example, the electronic device 900 may include a first support body (like 910), a second support body (like 960) on the first support body, and a cover (like 950) which faces the first support body with the second sound conduit (like 932) therebetween and is coupled to the second support body at the closed end 932a of the second sound conduit.

In an embodiment, when the widthwise center of the radiation opening 1135 is located spaced apart from the widthwise center of the vibration unit 1120 in the width direction of the electronic device 1100, the electronic device 1100 may include a third tube 1133 connected to the first tube 1131 and extending in an opposite direction to the direction in which the widthwise center of the radiation opening 1135 is located with respect to the widthwise center of the vibration unit 1120. For example, the radiation opening 1135 has a center C2 in a second direction (e.g., the X-axis direction) crossing the first direction, the center C2 of the radiation opening is spaced apart from a center C1 of the vibration generator (like 1120) in a direction (e.g., positive X-axis direction) along the second direction, and the sound conduit (like 1130) further includes a third sound conduit (like 1133) connected to the first sound conduit (like 1131), the third sound conduit extended from the first sound conduit in a direction opposite to the direction (e.g., negative X-axis direction) in which the center of the radiation opening is spaced apart from the center of the vibration generator in the direction along the second direction.

An electronic device 200 according to an embodiment of the present disclosure includes a vibration unit 220 which generates sound, a support unit 210 which surrounds the vibration unit 220, a cover 250 which is disposed to be spaced apart from the vibration unit 220, and a conduit unit 230 formed by the cover 250 and the support unit 210, where the conduit unit 230 may include a radiation opening 235 for transmitting the sound to the outside of the electronic device 200, a first tube 231, which is connected to the radiation opening 235 at one end thereof and extends a first length L1, and a second tube 232, which is connected to the first tube 231 at the other end of the first tube 231, extends a second length L2 in the direction opposite to that of the radiation opening 235, and is shaped to have a closed end.

An electronic device 200 according to an embodiment includes a vibration generator which generates a sound, a support body in which the vibration generator is disposed, the support body having a radiation opening defined therein through which the sound is transmitted to outside the electronic device in a first direction the electronic device, and a cover which faces and is spaced apart from both the vibration generator and the support body, to define a sound conduit through which the sound generated by the vibration generator is transmitted. Here, the sound conduit includes a first sound conduit which overlaps the vibration generator and is connected to the radiation opening, a second sound conduit which extends from the first sound conduit in a direction opposite to the first direction, the second sound conduit having a closed end opposite to the first sound conduit, and the first sound conduit and the second sound conduit having a first width and a second width which is smaller than the first width, respectively, in a second direction crossing the first direction.

In an embodiment, a boundary between the first sound conduit and the second sound conduit is a first length from the radiation opening, and the closed end of the second conduit is a second length from the first sound conduit, in the direction opposite to the first direction. The vibration generator has a center in the first direction, and the first length of the first sound conduit includes a third length from the center of the vibration generator to the boundary. Here, the second length is derived based on the first length and the third length, according to the Equations discussed above.

The electronic device according to an embodiment of the present disclosure may be various forms of devices. The electronic device may include, for example, a portable communication device (e.g., a smartphone), a computer device, a portable multimedia device, a portable medical device, a camera, a wearable device, or a home appliance. The electronic device according to the embodiment of the present disclosure is not limited to the aforementioned devices.

Embodiments of the present disclosure and the terms used herein are not intended to limit the technical features described herein to specific embodiments, but should be understood to include various modifications, equivalents, or substitutes of the embodiments. With respect to the description of the drawings, similar or related components may be designated by similar reference numerals.

The singular form of a noun corresponding to an item may include one or more of the items unless the context clearly indicates otherwise. In this disclosure, “A or B,” “at least one of A and B,” “at least one of A or B,” “A, B, or C,” “at least one of A, B, and C,” and “at least one of A, B, or C” may each include any one of the items listed together with the corresponding phrase, or any possible combination thereof. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Terms such as “1st”, “2nd”, or ‘first’, “second” or “second-first”, “second-second,” “second-third”, etc. may be used simply to distinguish one component from another and do not limit the components in any other respect (e.g., importance or order).

When a component (e.g., the first) is mentioned as being “coupled” or “connected” to another component (e.g., the second), with or without the terms ‘functionally’ or “communicatively,” it means that the first component is connected to the second component directly (e.g., by wire), wirelessly, or through a third component. It will be understood that when an element is referred to as being related to another element such as being “coupled” or “on” another element, it can be directly on the other element or intervening elements may be present therebetween. In contrast, when an element is referred to as being related to another element such as “directly coupled” or “directly on” another element, there are no intervening elements present.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The term “module” as used in embodiments of the present disclosure may include a unit implemented in hardware, software, or firmware, and may be used interchangeably with terms such as logic, logic block, component, or circuit. A module may be an integral component or the smallest unit or part thereof which performs one or more functions. For example, according to an embodiment, a module may be implemented in the form of an ASIC (application-specific integrated circuit).

Embodiments of the present disclosure may be implemented as software (e.g., program 140) including one or more instructions stored on a storage medium (e.g., an internal memory 136 or an external memory 138) readable by a machine (e.g., an electronic device 101). For example, the processor (e.g., the processor 120) of the device (e.g., the electronic device 101) can call at least one of the stored instructions from the storage medium and execute it. This enables the device to operate to perform at least one function according to the called instruction. The one or more instructions may include code generated by a compiler or code which can be executed by an interpreter. The storage medium readable by the device may be provided in the form of a non-transitory storage medium. Here, “non-transitory” means only that the storage medium is a tangible device and does not include signals (e.g., electromagnetic waves), and this term does not distinguish between cases where data is stored permanently on the storage medium and cases where it is stored temporarily.

According to an embodiment, the methods according to various embodiments of the present disclosure may be provided in the form of a computer program product. A computer program product may be traded as a commodity between a seller and a buyer. A computer program product may be distributed in the form of a storage medium readable by a device (e.g., a compact disc read-only memory (CD-ROM)), or it may be distributed online (e.g., by download or upload) through an application store (e.g., Play Store™) or directly between two user devices (e.g., smartphones). In the case of online distribution, at least part of the computer program product may be temporarily stored or generated on a device-readable storage medium such as the manufacturer's server, the application store's server, or an intermediary server's memory.

According to an embodiment, each of the aforementioned components (e.g., modules or programs) may include one or more objects, and some of the multiple objects may be separated and disposed in other components. According to various embodiments, one or more of the aforementioned components or operations may be omitted, or one or more other components or operations may be added. Alternatively or additionally, multiple components (e.g., modules or programs) may be integrated into a single component. In such a case, the integrated component may perform one or more functions of each of the multiple components in a manner which is identical or similar to that performed by the corresponding component of the multiple components prior to integration.

According to an embodiment, the operations performed by a module, a program, or other component may be executed sequentially, in parallel, repeatedly, or heuristically, or one or more of the operations may be executed in a different order, omitted, or one or more other operations may be added.

What is claimed is:

1. An electronic device comprising:
a vibration generator which generates a sound, the vibration generator having a center in a first direction; and
a sound conduit through which the sound generated by the vibration generator is transmitted, the sound conduit on a front surface of the vibration generator,
wherein
the sound conduit includes:
a radiation opening of the electronic device through which the sound is transmitted to outside of the electronic device from the sound conduit;
a first sound conduit which is connected to the radiation opening at a first end of the first sound conduit; and
a second sound conduit which is connected to the first sound conduit at a second end of the first sound conduit which is opposite to the first end, the second sound conduit having a closed end opposite to the first sound conduit;
the first sound conduit extending a first length in the first direction from the radiation opening;
the second sound conduit extending a second length in the first direction from the second end of the first sound conduit; and
the first sound conduit extending a third length in the first direction from the center of the vibration generator to the second end of the first conduit; and
the second length is derived based on the first length and the third length.

2. The electronic device of claim 1, wherein
a first effective length of the sound conduit is derived from a shape of the sound conduit, and
the second length is further derived based on the first length, the third length and the first effective length.

3. The electronic device of claim 2, wherein
a measured sound pressure level of the electronic device includes a sound speed of air located inside the sound conduit and a peak of sound pressure generated from the vibration generator, when the sound conduit has a minimum second length,
the second length of the sound conduit satisfies [Equation 1]
$$\frac{L 1 - 3 \times L 3}{2} < L 2 < \frac{L 1 e - 3 \times L 3}{2} ,$$
where
L1, L2 and L3 are the first length, the second length and the third length, respectively, and L1e is the first effective length, and
L1e satisfies [Equation 2]
$$L 1 e = \frac{3 \times c}{4 \times ( f\_peak )} ,$$
where ‘c’ represents the sound speed of air and ‘f_peak” represents a frequency of the vibration generator which corresponds to the peak of sound pressure.

4. The electronic device of claim 1, wherein
each of the first sound conduit and the second sound conduit has a width in a second direction crossing the first direction, and
the width of the second sound conduit is smaller than the width of the first sound conduit.

5. The electronic device of claim 1, wherein the second sound conduit includes a plurality of sub-sound conduits arranged spaced apart from each other in a second direction crossing the first direction.

6. The electronic device of claim 5, wherein the plurality of sub-sound conduits have different widths in the second direction.

7. The electronic device of claim 5, wherein a sum of the widths of the plurality of sub-sound conduits is smaller than a width of the first sound conduit in the second direction.

8. The electronic device of claim 1, wherein the second sound conduit has a major dimension extended along a second direction crossing the first direction.

9. The electronic device of claim 1, further comprising:
a support body in which the vibration generator is disposed, the support body surrounding the vibration generator, and
a cover which faces the vibration generator with the first sound conduit therebetween and faces the support body with the second sound conduit therebetween.

10. The electronic device of claim 9, further comprising an adhesive member which is on the support body and couples the cover to the support body.

11. The electronic device of claim 9, wherein the cover is a display which visually displays information to the outside of the electronic device.

12. The electronic device of claim 9, wherein the support body comprises a portion which overlaps the front surface of the vibration generator at a fixed area of the support body.

13. The electronic device of claim 1, further comprising:
a support body in which the vibration generator is disposed; and
a cover including a cover area facing the support body with the second sound conduit therebetween,
wherein
the support body includes stainless steel, and
the sound conduit is a space at least partially surrounded by the vibration generator, the support body and the cover.

14. The electronic device of claim 1, further comprising:
a first support body;
a second support body on the first support body; and
a cover which faces the first support body with the second sound conduit therebetween and is coupled to the second support body at the closed end of the second sound conduit,
wherein
the first support body and the cover includes stainless steel, and
the sound conduit is a space at least partially surrounded by the vibration generator, the first support body, the cover and the second support body.

15. The electronic device of claim 1, wherein
the radiation opening has a center in a second direction crossing the first direction,
the center of the radiation opening is spaced apart from a center of the vibration generator in a direction along the second direction, and
the sound conduit further includes a third sound conduit connected to the first sound conduit, the third sound conduit extended from the first sound conduit in a direction opposite to the direction in which the center of the radiation opening is spaced apart from the center of the vibration generator in the direction along the second direction.

16. An electronic device comprising:
a vibration generator which generates a sound;
a support body in which the vibration generator is disposed, the support body surrounding the vibration generator in a plan view;
a cover which faces and is spaced apart from both the vibration generator and the support body; and
a sound conduit through which the sound generated by the vibration generator is transmitted,
wherein the sound conduit:
a radiation opening defined in the support body and through which the sound is transmitted to outside the electronic device in a first direction the electronic device;
a first sound conduit which is connected to the radiation opening at a first end of the first sound conduit, the first sound conduit extending a first length from the radiation opening, in a direction opposite to the first direction; and
a second sound conduit connected to the first sound conduit at a second end of the first sound conduit which is opposite to the first end, the second sound conduit extending a second length from the second end of the first sound conduit, in the direction opposite to the first direction, and having a closed end opposite to the first sound conduit.

17. The electronic device of claim 16, wherein
the vibration generator has a center in the first direction;
the first length of the first sound conduit includes a third length from the center of the vibration generator to the second end of the of the first sound conduit; and
a measured sound pressure level of the electronic device includes a sound speed of air located inside the sound conduit and a peak of sound pressure generated from the vibration generator, when the second conduit has a minimum second length; and
the second length of the sound conduit satisfies [Equation 1]
$$\frac{L 1 - 3 \times L 3}{2} < L 2 < \frac{L 1 e - 3 \times L 3}{2} ,$$
where
L1, L2 and L3 are the first length, the second length and the third length, respectively, and L1e is a first effective length, and
L1e satisfies [Equation 2]
$$L 1 e = \frac{3 \times c}{4 \times ( f\_peak )} ,$$
where ‘c’ represents the sound speed of air and ‘f_peak” represents a frequency of the vibration generator which corresponds to the peak of sound pressure.

18. An electronic device comprising:
a vibration generator which generates a sound;
a support body in which the vibration generator is disposed, the support body having a radiation opening defined therein through which the sound is transmitted to outside the electronic device in a first direction the electronic device; and
a cover which faces and is spaced apart from both the vibration generator and the support body, to define a sound conduit through which the sound generated by the vibration generator is transmitted,
wherein the sound conduit includes:
a first sound conduit which overlaps the vibration generator and is connected to the radiation opening;
a second sound conduit which extends from the first sound conduit in a direction opposite to the first direction, the second sound conduit having a closed end opposite to the first sound conduit; and
the first sound conduit and the second sound conduit having a first width and a second width which is smaller than the first width, respectively, in a second direction crossing the first direction.

19. The electronic device of claim 18, wherein
a boundary between the first sound conduit and the second sound conduit is a first length from the radiation opening, and the closed end of the second conduit is a second length from the first sound conduit, in the direction opposite to the first direction,
the vibration generator has a center in the first direction;
the first length of the first sound conduit includes a third length from the center of the vibration generator to the boundary;
a measured sound pressure level of the electronic device includes a sound speed of air located inside the sound conduit and a peak of sound pressure generated from the vibration generator, when the second conduit has a minimum second length; and
the second length of the sound conduit satisfies [Equation 1]
$$\frac{L 1 - 3 \times L 3}{2} < L 2 < \frac{L 1 e - 3 \times L 3}{2} ,$$
where
L1, L2 and L3 are the first length, the second length and the third length, respectively, and L1e is a first effective length, and
L1e satisfies [Equation 2]
$$L 1 e = \frac{3 \times c}{4 \times ( f\_peak )} ,$$
where ‘c’ represents the sound speed of air and ‘f_peak” represents a frequency of the vibration generator which corresponds to the peak of sound pressure.

20. The electronic device of claim 18, wherein
each of the first sound conduit and the second sound conduit has a width in a second direction crossing the first direction, and
the width of the second sound conduit is smaller than the width of the first sound conduit.
